(19) United States
(12) Patent Application Publication
(10) Pub. No.: US 2025/0307568 A1
(43) Pub. Date: Oct. 2, 2025

(54) TECHNIQUES FOR RESPONDING TO A USER QUERY USING NATURAL LANGUAGE PROCESSING AND A MULTI-TIERED LARGE LANGUAGE MODEL APPROACH

(71) Applicant: NORTHERN LIGHT GROUP, LLC, Boston, MA (US)

(72) Inventors: C. David Seuss, Charlestown, MA (US); Anton Voskresenskiy, Santa Barbara, CA (US)

(21) Appl. No.: 19/092,681

(22) Filed: Mar. 27, 2025

Related U.S. Application Data
(60) Provisional application No. 63/571,878, filed on Mar. 29, 2024.

(51) Int. Cl. G06F 40/40; G06F 16/903; G06F 16/93

(52) U.S. Cl. CPC G06F 40/40; G06F 16/90335; G06F 16/93

(57) ABSTRACT

Techniques, performed by a computing system, of responding to a query from a user are provided according to various embodiments. A method includes: (a) searching a database of documents, yielding a set of returned documents responsive to the query; (b) for each document of a subset of the set of returned documents, sending a reduced-length version of that document to a first large language model (LLM) with a first prompt requesting a summary of that document, the reduced-length version having been processed using natural language processing (NLP); (c) in response to receiving the requested summaries of the subset of documents, sending the summaries of the subset of documents to a second LLM with a second prompt requesting a meta-summary that summarizes the summaries of the subset of documents; and (d) displaying the meta-summary to the user. A corresponding system, apparatus, and computer program product are also provided.

### CROSS-REFERENCE TO RELATED APPLICATIONS

This Application claims priority under 35 U.S.C. § 119(e) to U.S. Provisional Patent Application 63/571,878, titled “TECHNIQUES FOR RESPONDING TO A USER QUERY USING NLP AND A MULTI-TIERED LLM APPROACH,” filed on Mar. 29, 2024, the contents of which are incorporated herein by reference in their entirety for all purposes.

### BACKGROUND

When a user wishes to learn information about a question, s/he may perform a search on either the Internet (e.g., the World Wide Web, WWW) or on a database of documents. Some search engines sort the returned documents in order of relevance to the search query as determined by the search engine. The user may then read the first few results and arrive at an answer to the question based upon that information.

Alternatively, a user may pose the question to a generative large language model (LLM) trained on a set of documents (e.g., the WWW). This tends to produce a concise answer to the question without needing to read several documents.

### SUMMARY

Unfortunately, the above-described approaches suffer from deficiencies. The search technique requires the user to read and digest several documents in order to arrive at an answer, which may take more time and effort than the user would like. The generative LLM technique does provide a concise answer without much time and effort, but it is limited to the accumulated knowledge of the generative LLM at the time that it was trained. In addition, generative LLMs tend to suffer from the hallucination problem in which information is made up, and the user cannot be sure that the answer is accurate.

Thus, it would be desirable to implement a tool that provides a concise answer without much time and effort that is able to remain up-to-date with newly-published information while avoiding the hallucination problem and allowing the user to verify its accuracy. There are several ways that this may be accomplished by performing a search on a database. In some embodiments, a system may feed reduced-length versions (e.g., processed using natural language processing) of the top search results through an LLM to produce a summary. This approach allows a large number of documents to be summarized by an LLM even though a token limit of the LLM would not have been large enough to include all of the documents in their entirety. This approach can also provide increased speed and reduced memory requirements. In some embodiments, the system may feed the top search results through an LLM to produce summaries, and then ask an LLM to generate a meta-summary of those summaries. In some embodiments, multiple databases may be searched separately, and one or both of the previous approaches may be used to produce a summary (or meta-summary) of some of the documents returned by the search of each database. These summaries can then be fed into an LLM to produce a meta-summary (or meta-meta-summary) that combines the results from the different databases. In any of these approaches, hallucinations and inaccuracies can be reduced by also prompting the LLM to include linked citations in the summary, meta-summary, and/or meta-meta-summary.

A method, performed by a computing system, of responding to a query from a user is provided according to various embodiments. The method includes: (a) searching a database of documents, yielding a set of returned documents responsive to the query; (b) for each document of a subset of the set of returned documents, sending a reduced-length version of that document to a first large language model (LLM) with a first prompt requesting a summary of that document, the reduced-length version having been processed using natural language processing (NLP); (c) in response to receiving the requested summaries of the subset of documents, sending the summaries of the subset of documents to a second LLM with a second prompt requesting a meta-summary that summarizes the summaries of the subset of documents; and (d) displaying the meta-summary to the user. A corresponding system, apparatus, and computer program product for performing this method and similar methods is also provided according to various embodiments. Other methods, systems, apparatuses, and computer program products are also provided for techniques according to other embodiments.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example system, apparatus, computer program product, and associated data structures for use in connection with one or more embodiments.

FIG. 2 illustrates an example method in accordance with one or more embodiments.

FIG. 3 illustrates an example search results page for use in connection with one or more embodiments.

FIG. 4 illustrates an example system, apparatus, computer program product, and associated data structures for use in connection with one or more embodiments.

FIG. 5 illustrates an example method in accordance with one or more embodiments.

### DETAILED DESCRIPTION

### Introduction

This disclosure covers at least three example versions (designated as versions α, β and γ), which may either be used independently or in combination.

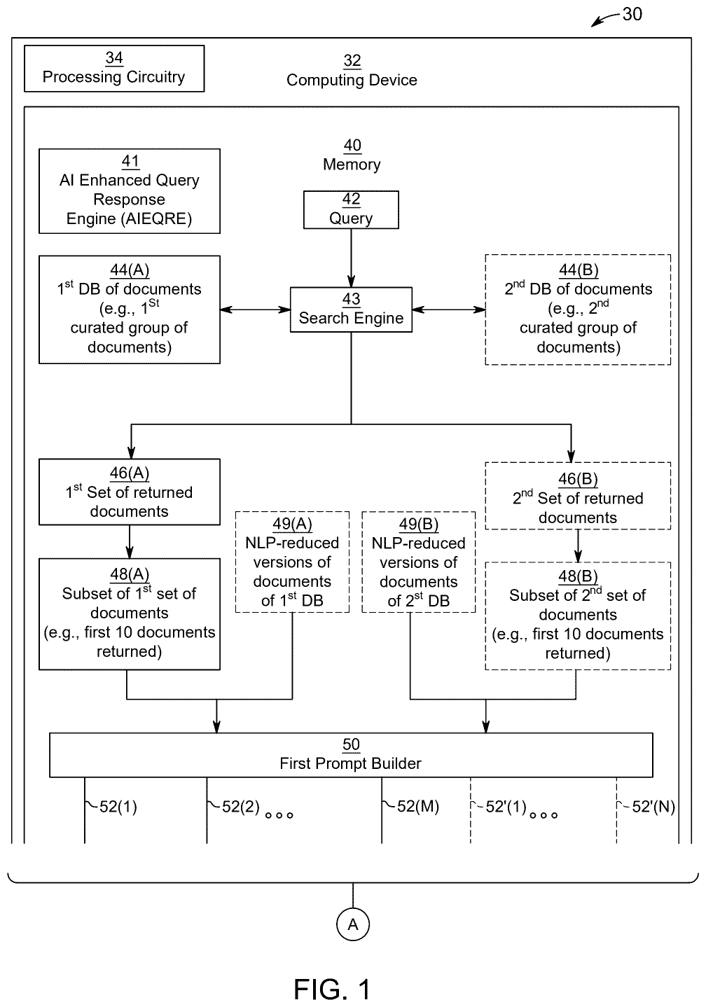

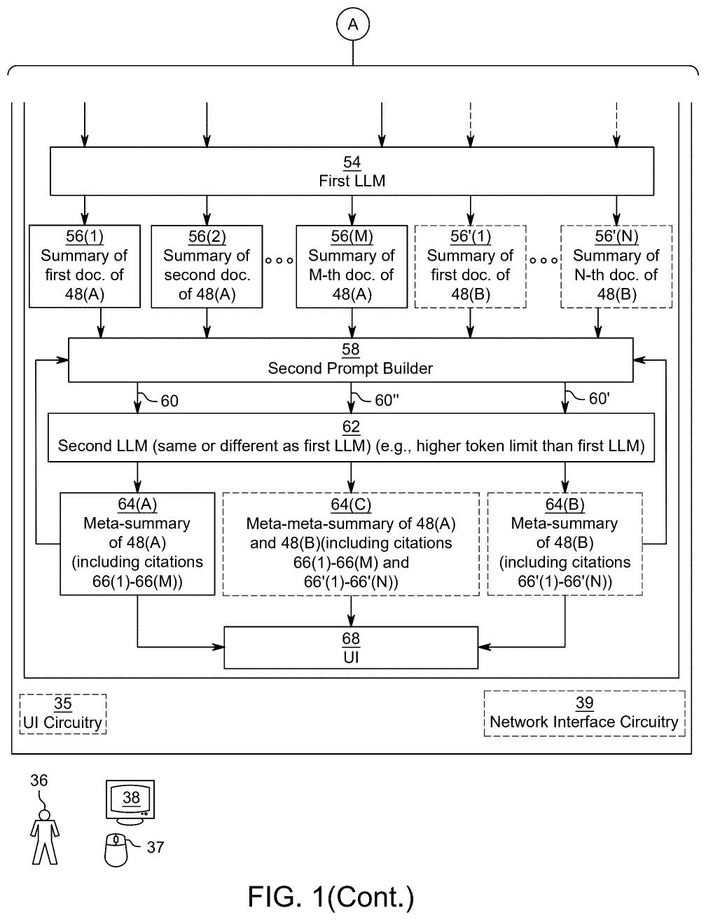

A first example version (referred to as version α), primarily described in connection with FIGS. 1-3, relates to first processing search results through a first large language model (LLM) for summarization of individual search results and then processing the summaries through a second LLM (possibly identical to the first LLM) to create a meta-summary.

A second example version (referred to as version β), also described in connection with FIGS. 1-3, relates to processing search results for each of a plurality of document databases through one or more LLMs for summarizing the search results for that database, and then processing those summaries (or meta-summaries) through a second LLM (possibly identical to the first LLM) to create a meta-summary (or meta-meta-summary). In connection with FIGS. 1-3, version β is described in combination with version α (and optionally also the version γ), but it can also be performed separately from the version α.

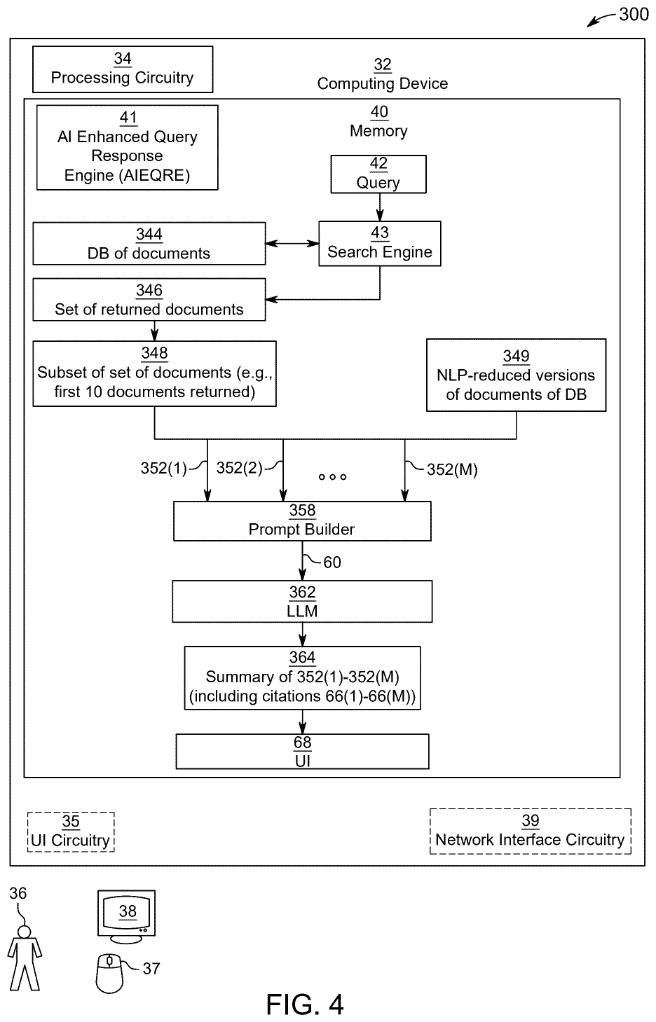

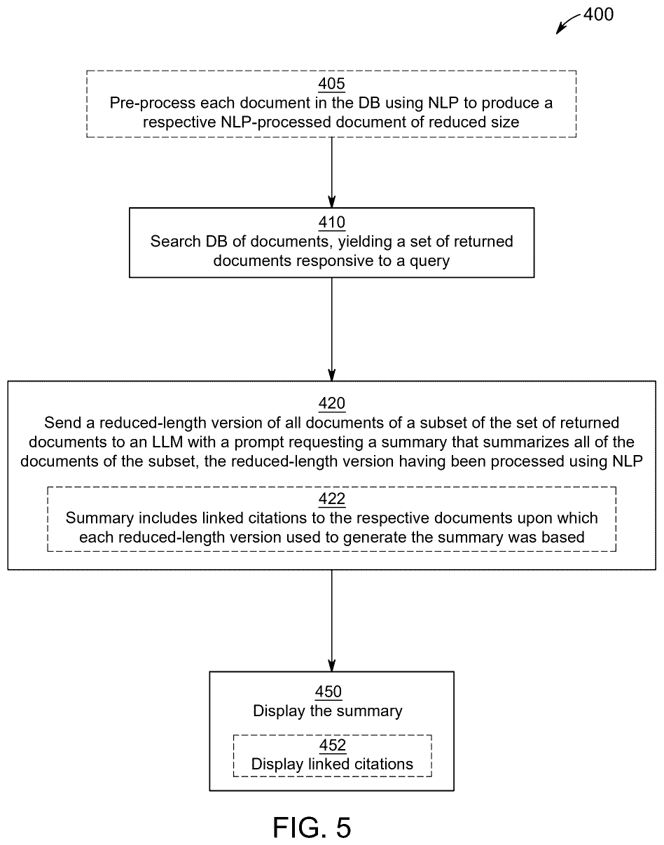

A third example version (referred to as version γ), primarily described in connection with FIGS. 4-5, relates to reducing the effective size of search results using natural language processing (NLP) prior to using an LLM to summarize their contents. In addition to being described in connection with FIGS. 4-5 on its own, this example version is also described used in conjunction with the version α (and optionally β) in connection with FIGS. 1-3.

### Description

FIG. 1 depicts an example system 30 for use in connection with various embodiments described herein. System 30 includes a computing device 32 operated by a user 36.

Computing device 32 may be any kind of computing device, such as, for example, a personal computer, laptop, workstation, server, enterprise server, tablet, smartphone, etc. Computing device 32 includes processing circuitry 34 and memory 40. Computing device 32 also includes at least one of user interface (UI) circuitry 35, and network interface circuitry 39. Computing device 32 may also include various additional features as is well-known in the art, such as, for example, a housing, interconnection buses, etc. Computing device 32 may be operated by a user 36 using or more user input devices 37 and display screens 38 to perform a query 42 and display a concise answer, such as a meta-summary 64(A) and/or a meta-meta-summary 64(C) in response.

UI circuitry 35 may include any circuitry needed to communicate with and connect to one or more user input devices 37 and display screens 38. UI circuitry 35 may include, for example, a keyboard controller, a mouse controller, a touch controller, a serial bus port and controller, a universal serial bus (USB) port and controller, a wireless controller and antenna (e.g., Bluetooth), a graphics adapter and port, etc. In some embodiments, instead of the user input devices 37 and display screens 38 connecting directly to UI circuitry 35 of the computing device 32, user 36 may operate a separate user device (e.g., a personal computer, laptop, tablet, smartphone, etc., not depicted) having UI circuitry 35 and network interface circuitry 39; the separate device connects to the computing device 32 via a network (not depicted). In such embodiments, user 36 may operate a web browser on the separate user device to connect to a web server (not depicted) running on the computing device 32

Network interface circuitry 39 may include one or more Ethernet cards, cellular modems, Fibre Channel (FC) adapters, InfiniBand adapters, wireless networking adapters (e.g., Wi-Fi), and/or other devices for connecting the computing device 32 and the separate user device to the network, such as, for example, a LAN, WAN, SAN, the Internet, a wireless communication network, a virtual network, a fabric of interconnected switches, etc.

Display screen 38 may be any kind of display, including, for example, a CRT, LCD screen, LED screen, etc. Input device 37 may include a keyboard, keypad, mouse, trackpad, trackball, pointing stick, joystick, touchscreen (e.g., embedded within display screen 38), microphone/voice controller, etc. In some embodiments, instead of being external to computing device 32 or the separate user device, the input device 37 and/or display screen 38 may be embedded within the computing device 38 or the separate user device (e.g., a cell phone or tablet with an embedded touchscreen).

Processing circuitry 34 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Memory 40 may include any kind of digital system memory, such as, for example, random access memory (RAM), read-only memory (ROM), one-time programmable (OTP) memory, and/or flash memory. Memory 40 stores an operating system (OS, e.g., a Linux, UNIX, Windows, MacOS, or similar operating system, not depicted) and various drivers (not depicted) and other applications and software modules configured to execute on processing circuitry 34.

In operation, user 36 inputs a query 42 using the one or more user input devices 37. An example query 42 might be “What is the Fed expected to do to interest rates over the next year?”. Other example queries 42 are “Will consumers pay more for sustainable products?”, “What are the trends in fintech?”, and “What is Pfizer's strategy in oncology?”.

Artificial Intelligence (AI) Enhanced Query Response Engine (AIEQRE) 41 then feeds query 42 into a search engine 43 which searches one or more databases (DBs) 44 of documents. In some embodiments, search engine 43 searches only a first DB 44(A), while in other embodiments, search engine 43 also searches a second DB 44(B). In yet other embodiments, search engine 43 may also search one or more additional DBs 44. In some embodiments, a DB 44 may be a curated group of documents, such as, for example, news reports from financial institutions, corporate financial reports, etc. The curation helps increase the quality of the final results by ensuring high quality input data.

Search engine 43 outputs a set 46 of returned documents from the search of each DB 44. For example, first set 46(A) is output in response to searching first DB 44(A), second set 46(B) is output in response to searching second DB 44(B), etc. AIEQRE 41 generates a subset 48 of each set 46 of returned documents for further processing. Thus, first subset 48(A) is generated from first set 46(A), second subset 48(B) is generated from second set 46(B), etc. In one embodiment, AIEQRE 41 selects the first 10 documents from each set 46 of returned documents for inclusion in the subset 44. In another embodiment, AIEQRE 41 selects the first 20 documents from each set 46 of returned documents for inclusion in the subset 44. In another embodiment, embodiment, AIEQRE 41 dynamically decides how many documents to select from each set 46 based upon an analysis of the contents of the returned documents.

In some embodiments (i.e., version γ when used in connection with version α and/or β), each document in each DB 44 has an associated reduced-size version 49 that was produced by performing NLP. Thus, each document in first DB 44(A) has an associated reduced-size version 49(A), and each document in second DB 44(B) has an associated reduced-size version 49(B), etc. In some embodiments, the NLP may have been performed in advance using techniques for text extraction, syntactic parsing, and candidate summary sentence detection such as those described in U.S. Patent Publication 2019/0129942 A1 entitled “Methods and systems for automatically generating reports from search results,” published May 2, 2019, the entire contents and teachings of which are hereby incorporated herein by this reference. In some embodiments, the NLP may (also) have been performed in advance using techniques for key concept analysis such as those described in U.S. Pat. No. 11,886,477 B2 entitled “System and method for quote-based search summaries,” issued Jan. 30, 2024, the entire contents and teachings of which are hereby incorporated herein by this reference.

AIEQRE 41 feeds either the individual documents of the first subset 48(A) (when version γ is not used) or the associated reduced-size version 49(A) of each document in the first subset 48(A) (when version γ is used in connection with version α and/or β) into a first prompt builder 50 configured to generate a respective prompt 52 for first large language model (LLM) 54. Thus, if there are M documents in subset 48(A), first prompt builder 50 generates M prompts 52(1), 52(2), . . . , 52(M). Each prompt 52(X) includes the complete text of either document X of the first subset 48(A) (when version γ is not used) or the associated reduced-size version 49(A) of document X from the first subset 48(A) (when version γ is used in connection with version α and/or β) as well as instructions for the first LLM 54 asking it to generate a summary 56(X) of that document. For example, each prompt 52(X) may ask for the summary 56(X) to not exceed 150 (or some other value, such as 250, 300, 500, etc.) tokens long. In some embodiments, AIEQRE 41 also feeds either the individual documents of the second subset 48(B) (when version γ is not used) or the associated reduced-size version 49(B) of each document in the second subset 48(B) (when version γ is used in connection with versions β and α) into the first prompt builder 50 configured to generate a respective prompt 52′ for first LLM 54. Thus, if there are N documents in subset 48(B), first prompt builder 50 generates N prompts 52′(1), 52′(2), . . . , 52′(N).

AIEQRE 41 feeds the summaries 56 of each document in the first subset 48(A) generated by first LLM 54 into a second prompt builder 58 configured to generate a single prompt 60 for second LLM 62. Thus, the single prompt 60 asks second LLM 62 to generate a meta-summary 64(A) of all the summaries 56(1), 56(2), . . . , 56(M). In some embodiments, prompt 60 asks second LLM 62 to not exceed 3000 (or another value, such as 5000, 10,000, etc.) tokens in length. In some embodiments, prompt 60 asks second LLM 62 to use content from as many of the summaries 56(1), 56(2), . . . , 56(M) as possible. In some embodiments, prompt 60 asks second LLM 62 to include a citation 66 for every sentence in the meta-summary 64(A) to one or more of the summaries 56(1), 56(2), . . . , 56(M) as its source to allow the user 36 to easily verify the source and accuracy of the contents of the meta-summary 64(A).

In some embodiments, the second LLM 62 is identical to (and the same code as) the first LLM 54. In other embodiments, the second LLM 62 may be different than (e.g., made up of different code than) the first LLM 54 or the first LLM 54 and the second LLM 62 may share the same code but be configured with different options. For example, the second LLM 62 may have a higher token limit than the first LLM 54 (e.g., 16 k tokens vs. 4 k tokens or 32 k tokens vs. 8 k tokens). In some embodiments, the first LLM 54 may be GPT-3.5 Turbo produced by OpenAI, Inc. of San Francisco, CA and the second LLM 62 may be GPT-4 or GPT-4 Turbo also produced by OpenAI.

In some embodiments, AIEQRE 41 also feeds the summaries 56′ of each document in the second subset 48(B) generated by first LLM 54 into second prompt builder 58, which is also configured to generate a single prompt 60′ for second LLM 62. Thus, the single prompt 60′ asks second LLM 62 to generate a meta-summary 64(B) of all the summaries 56′(1), 56′(2), . . . , 56′(N). In some embodiments, prompt 60′ asks second LLM 62 to use content from as many of the summaries 56′(1), 56′(2), . . . , 56′(N) as possible. In some embodiments, prompt 60′ asks second LLM 62 to include a citation 66′ for every sentence in the meta-summary 64(B) to one or more of the summaries 56′(1), 56′(2) , . . . , 56′(N) as its source to allow the user 36 to easily verify the source and accuracy of the contents of the meta-summary 64(B).

In some embodiments (i.e., when version β is used without version α), instead of AIEQRE 41 feeding summaries 56 and 56′ into second prompt builder 58, the first prompt builder 50 may be bypassed, so the documents of subset 48(A) are fed directly into second prompt builder 58 to produce prompt 60, and the documents of subset 48(B) are fed directly into second prompt builder 58 to produce prompt 60′.

In some embodiments (i.e., when version β is used, regardless of whether version α and/or γ is also used), AIEQRE 41 also feeds the meta-summaries 64(A), 64(B) (and possibly additional meta-summaries) generated by second LLM 62 back into second prompt builder 58, which is also configured to generate a single prompt 60″ for second LLM 62. Thus, the single prompt 60″ asks second LLM 62 to generate a meta-meta-summary 64(C) of all the meta-summaries 64(A), 64(B). In some embodiments, prompt 60″ asks second LLM 62 to use content from as many of the summaries 56(1), 56(2), . . . , 56(M) (or from the documents of first subset 48 (A) ) and 56′(1) , 56′(2) , . . . , 56′(N) (or from the documents of second subset 48(B)) as possible. In some embodiments, prompt 60″ asks second LLM 62 to include a citation 66, 66′ for every sentence in the meta-meta-summary 64(C) to one or more of the summaries 56(1), 56(2), . . . , 56(M) (or to the documents of first subset 48(A)) and 56′(1), 56′(2), . . . , 56′(N) (or to the documents of second subset 48(B)) as its source to allow the user 36 to easily verify the source and accuracy of the contents of the meta-meta-summary 64(C).

AIEQRE 41 then outputs at least one of meta-summary 64(A) or meta-meta-summary 64(C) to UI 68 to be displayed to the user 36 on display screen 38. In some embodiments, AIEQRE 41 also outputs the summaries 56 used to generate the meta-summary 64(A) to UI 68. In some embodiments, AIEQRE 41 also outputs the summaries 56, 56′ used to generate the meta-summaries 64(A), 64(B) into UI 68.

In some embodiments, the use of a question mark at the end of the query 42 triggers the use of AIEQRE 41; otherwise, only the sets 46 or subsets 48 are displayed in UI 68 without calling LLMs 54, 62.

Memory 40 of the computing device 32 may also store various other data structures used by the OS, AIEQRE 41, search engine 43, prompt builders 50, 58, LLMs 54, 62, UI 68, and various other applications and drivers.

In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32 is powered off. The OS, AIEQRE 41, search engine 43, prompt builders 50, 58, LLMs 54, 62, UI 68, and/or various other applications and drivers may be stored in this persistent storage portion of memory 40 so that they may be loaded into a system portion of memory 40 upon a system restart or as needed. The OS, AIEQRE 41, search engine 43, prompt builders 50, 58, LLMs 54, 62, UI 68, and various other applications and drivers, when stored in non-transitory form either in the volatile or persistent portion of memory 40, each form a computer program product. The processing circuitry 34 running one or more applications thus forms a specialized circuit constructed and arranged to carry out the various processes described herein.

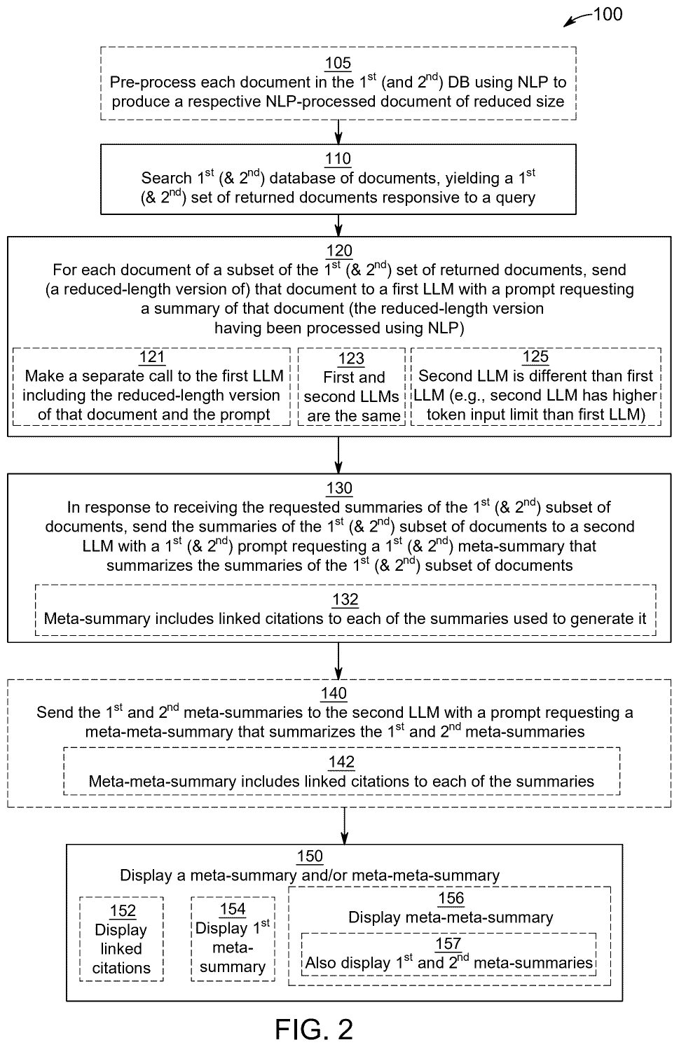

FIG. 2 illustrates an example method 100 performed by a system 30 for responding to a query from a user 36. It should be understood that any time a piece of software (e.g., OS, AIEQRE 41, search engine 43, prompt builders 50, 58, LLMs 54, 62, UI 68, etc.) is described as performing a method, process, step, or function, what is meant is that a computing device (e.g., computing device 32, separate user device, etc.) on which that piece of software is running performs the method, process, step, or function when executing that piece of software on its processing circuitry 34. It should be understood, that one or more of the steps or sub-steps of method 100 may be omitted in some embodiments. Similarly, in some embodiments, one or more steps or sub-steps may be combined or performed in a different order. Dashed lines indicate that a step or sub-step is either optional or representative of alternate embodiments or use cases.

In step 105, which is preliminary to the rest of method 100, AIEQRE 41 pre-processes each document in the first DB 44(A) of documents using NLP to produce a respective NLP-processed document of reduced size 49(A). Similarly, in some embodiments, AIEQRE 41 also pre-processes each document in the second DB 44(B) of documents using NLP to produce a respective NLP-processed document of reduced size 49(B). Step 105 may be performed in advance, but it is also ongoing as new documents are added to the DBs 44.

In step 110, search engine 43 searches the first DB 44(A) of documents based on the query 42, yielding a first set 46(A) of returned documents responsive to the query 42. In some embodiments, search engine 43 also searches the second DB 44(B) of documents based on the query 42, yielding a second set 46(B) of returned documents responsive to the query 42. AIEQRE 41 then generates the subsets 48(A), 48(B) from the sets 46(A), 46(B), respectively.

In step 120, for each document of the first subset 48(A), first prompt builder 50 generates a prompt 52 and sends that prompt 52 to the first LLM 54 together with either that document (when version γ is not used) or the NLP-reduced version 49(A) of that document (when version γ is used in connection with version α and/or β) to request a summary of that document. In some embodiments, for each document of the second subset 48(B), first prompt builder 50 also generates a prompt 52′ and sends that prompt 52′ to the first LLM 54 together with either that document (when version γ is not used) or the NLP-reduced version 49(B) of that document (when version γ is used in connection with version β and possibly also α) to request a summary of that document.

In some embodiments, step 120 includes sub-step 121 in which a separate call is made to the first LLM 54 for each document of the first subset 48(A), so each of the M prompts 52(1), 52(2), . . . 52(M) is sent to the first LLM 54 separately. Similarly, in some embodiments, a separate call is made to the first LLM 54 for each document of the second subset 48(B), so each of the N prompts 52′(1), 52′(2), . . . 52′(N) is sent to the first LLM 54 separately.

In some embodiments, step 120 includes sub-step 123, and in other embodiments, step 120 includes sub-step 125. In sub-step 123 the first LLM 54 is the same as the second LLM 62. In sub-step 125 the first LLM 54 is different from the second LLM 62 (e.g., the second LLM 62 has or is configured with a higher token input limit than the first LLM 54).

When version β is performed without version α, step 120 is skipped.

In step 130, (in response to receiving all of the requested summaries 56 of the documents of the first subset 48(A) from the first LLM 54), second prompt builder 58 generates a prompt 60 requesting a meta-summary 64(A) of the summaries 56 (or the documents of subset 48(A) if version β is performed without version α) and sends that prompt 60 to the second LLM 62 together with the summaries 56 (or the documents of subset 48(A) if version β is performed without version α). In some embodiments, (in response to receiving all of the requested summaries 56′ of the documents of the second subset 48(B) from the first LLM 54), second prompt builder 58 also generates a prompt 60′ requesting a meta-summary 64(B) of the summaries 56′(or the documents of subset 48(B) if version β is performed without version α) and sends that prompt 60′ to the second LLM 62 together with the summaries 56′(or the documents of subset 48(B) if version β is performed without version α). In some embodiments, step 130 includes sub-step 132 in which the prompt 60 (and 60′) includes a request to include citations 66 (or 66′) to each of the summaries 56 (or 56′) (or to the documents of first subset 48(A) and second subset 48(B) when version β is performed without version α) used to generate the meta-summary 64(A) (or 64(B)).

In some embodiments (e.g., version β), in step 140, in response to receiving the requested meta-summaries 64(A), 64(B) from the second LLM 62, second prompt builder 58 generates a prompt 60″ requesting a meta-meta-summary 64(C) that summarizes the meta-summaries 64(A), 64(B) and sends that prompt 60″ to the second LLM 62 together with the meta-summaries 64(A), 64(B). In some embodiments, step 140 includes sub-step 142 in which the prompt 60″ includes a request to include citations 66, 66′ to each of the summaries 56, 56′(or to the documents of first subset 48(A) and second subset 48(B) when version β is performed without version α) used to generate the meta-meta-summary 64(A), 64(B).

In step 150, UI 68 displays a meta-or meta-meta-summary 64. Depending on the embodiment, step 150 includes sub-step 154 and/or 156.

In sub-step 154, UI 68 displays the first meta-summary 64(A). Sub-step 154 is performed without sub-step 156 in embodiments in which only the first DB 44(A) is searched.

In sub-step 156, UI 68 displays the meta-meta-summary 64(C). In some embodiments, sub-step 156 is performed without sub-step 154. In embodiments in which sub-step 156 is performed with sub-step 154, sub-step 157 is also performed, in which UI 68 also displays the second meta-summary 64(B). In embodiments in which all of sub-steps 154, 156, 157 are performed, the various meta-and meta-meta-summaries 64 might not all be displayed on the display screen 38 simultaneously as there may not be room. Rather, there may be multiple tabs displayed allowing the user 36 toggle between viewing the first meta-summary 64(A), the second meta-summary 64(B), and the meta-meta-summary 64(C).

In some embodiments (e.g., in embodiments in which sub-step 132 or 142 was performed), sub-step 152 may be performed, in which UI 68 displays citations 66, 66′ that link to the relevant summaries 56, 56′ or to the relevant documents of the subset(s) 48.

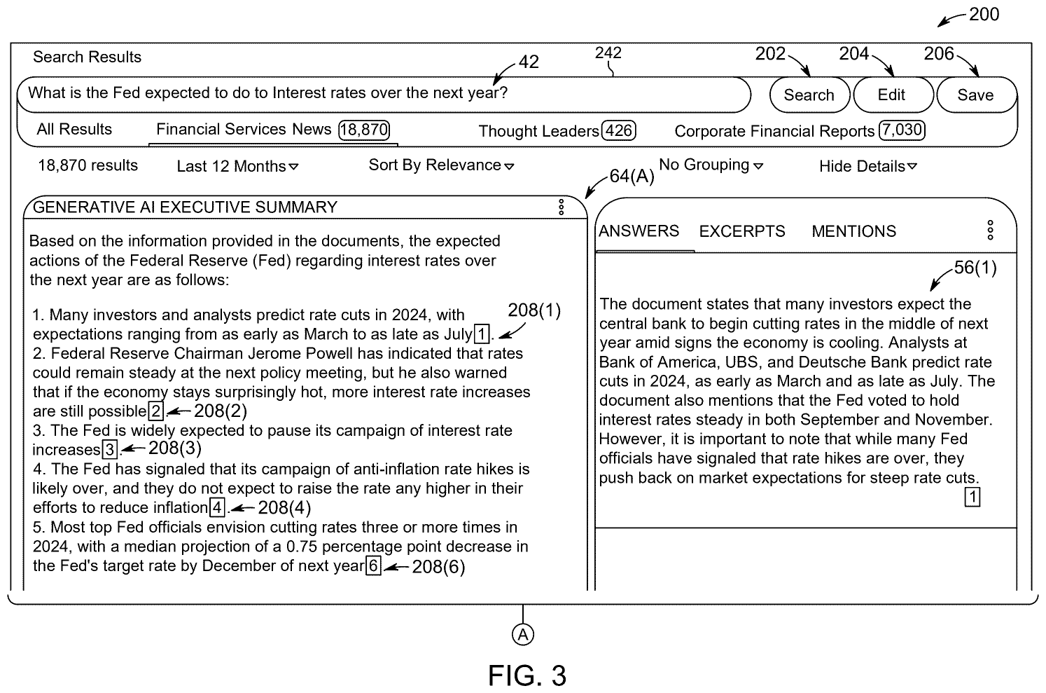

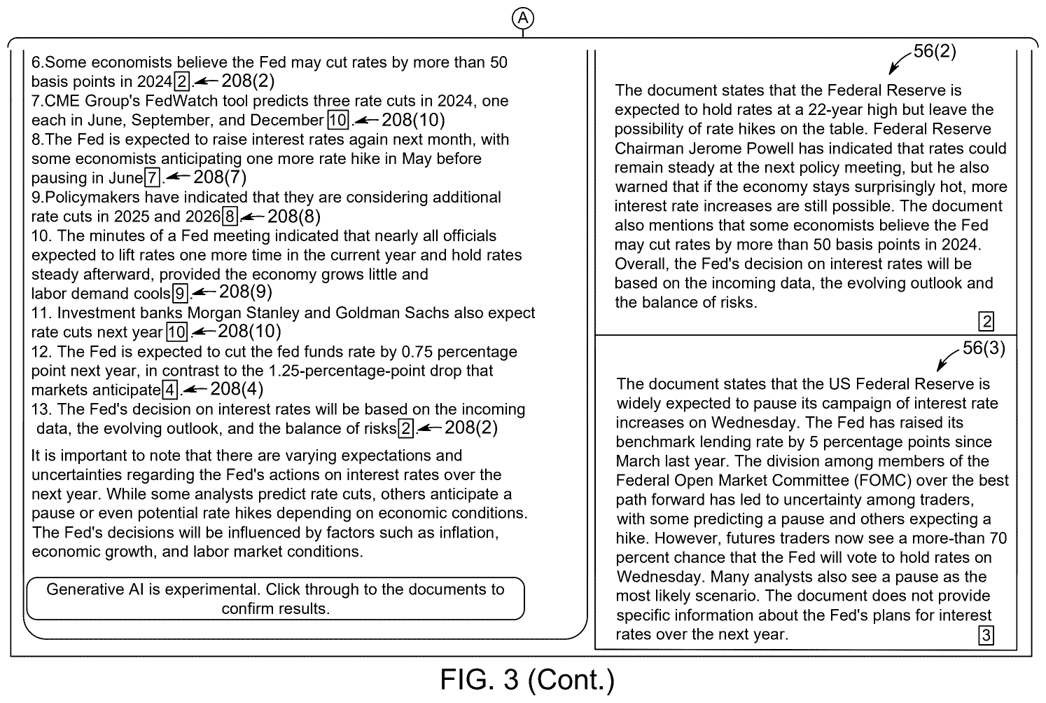

FIG. 3 depicts an example screen 200 that may be included within UI 68. Screen 200 includes a query box 242 that displays the query 42 and at least one meta-or meta-meta- summary 64. In some embodiments, query box 242 is editable, allowing the user 36 to edit the query 42 and then re-submit it using the search button 202. In some embodiments, there may be an edit button 204, which, upon selection by the user 36 brings up another screen (not depicted) that allows the user 36 to edit details of the search parameters aside from the query 42 itself (e.g., a date range, how to sort the results, how many documents to use within the subset 46, and which DB or DBs 44 to search). In some embodiments, there may be a save button 206, which allows the user 36 to save the query 42 for later use.

As depicted in FIG. 3, screen 200 includes first meta-summary 64(A) as well as several of the summaries 56 (e.g., first three summaries 56(1), 56(2), 56 (3)). First meta-summary 64(A) includes linked citations 208, including citation 208(1) that references and links to summary 56(1) (or the first document of first subset 48(A)), citation 208(2) that references and links to summary 56(2) (or the second document of first subset 48(A)), citation 208 (3) that references and links to summary 56 (3) (or the third document of first subset 48(A)), etc.

FIG. 4 depicts a system 300 used in connection with version γ. System 300 is similar to system 30 except for some of the contents of memory 40, as noted. Only one DB of documents 344 (and related items) is depicted. The search engine 43 returns a single set 346 of returned documents, and there is a single subset 348 of the set 346 of returned document. NLP-reduced versions of the DB 344 are referenced in connection with the documents of the subset 348 to send M NLP-reduced documents 352(1), 352(2), . . . , 352(M) (corresponding to the M documents in the subset 348) to prompt builder 358 (which replaces both of the prompt builders 50, 58 from system 30). The prompt 60 is then fed into single LLM 362 to generate single summary 364 of NLP-reduced documents 352(1), 352(2), . . . , 352 (M) , which may also include citations 66. Summary 364 is displayed on screen 38 via UI 68.

FIG. 5 depicts a method 400 connection with version γ. Step 405 for pre-processing using NLP is optional. Step 410 is similar to step 110.

Step 420 combines steps 120 and 130 while using NLP-reduced documents 352(1), 352(2), . . . , 352(M) to directly generate summary 364. In embodiments in which step 405 was not performed, the NLP processing is performed on the fly. In some embodiments, step 420 may include sub-step 422. Step 450 follows. Step 450 is similar to step 150, but only summary 364 is displayed (optionally with linked citations, as in sub-step 452).

Thus, a tool that allows a user 36 to obtain a concise answer 64 without much time and effort that is able to remain up-to-date with newly-published information while avoiding the hallucination problem and allowing the user 36 to verify its accuracy has been described. The user 36 is able to perform a search of a query 42 on one or more DBs 44, 344. In some embodiments (i.e., when version γ is used), a system 300 may feed reduced-length versions 49, 352 (e.g., processed using natural language processing) of the top search results 48, 348 through an LLM 54, 362 to produce a summary. This approach allows a large number of documents to be summarized by an LLM 362 even though a token limit of the LLM 362 would not have been large enough to include all of the documents in their entirety. This approach can also provide increased speed and reduced memory requirements. In some embodiments (i.e., when version α is used), the system 30 may feed the top search results 48 through an LLM 54 to produce summaries 56 (and 56′ in some embodiments, such as version β), and then asking an LLM 62 to generate a meta-summary 64(A) of those summaries 56. In some embodiments (i.e., when version β is used), multiple databases 44(A), 44(B) may be searched separately, and one or both of the previous approaches may be used to produce a summary (or meta-summary 60, 60′) of some of the documents returned by the search of each database 44. These meta-summaries 60, 60′ can then be fed into an LLM 62 to produce a meta-meta-summary 60″ that combines the results from the different databases 44. In any of these approaches, hallucinations and inaccuracies can be reduced by also prompting the LLM to include linked citations 66, 66′, 208 in the meta-summary 64(A), 64(B).

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments. Furthermore, it should be understood that all embodiments which have been described may be combined in all possible combinations with each other, except to the extent that such combinations have been explicitly excluded.

What is claimed is:

1. A method, performed by a computing system, of responding to a query from a user, the method comprising:
searching a database of documents, yielding a set of returned documents responsive to the query;
for each document of a subset of the set of returned documents, sending a reduced-length version of that document to a first large language model (LLM) with a first prompt requesting a summary of that document, the reduced-length version having been processed using natural language processing (NLP);
in response to receiving the requested summaries of the subset of documents, sending the summaries of the subset of documents to a second LLM with a second prompt requesting a meta-summary that summarizes the summaries of the subset of documents; and
displaying the meta-summary to the user.

2. The method of claim 1 wherein the second LLM is the first LLM.

3. The method of claim 1 wherein the second LLM is different than the first LLM.

4. The method of claim 3 wherein:
the second LLM has a higher token input limit than the first LLM; and
sending the reduced-length version of each document to the first LLM includes, for each document, making a separate call to the first LLM including the reduced-length version of that document and the first prompt.

5. The method of claim 1 wherein the meta-summary includes linked citations to each of the summaries.

6. The method of claim 1 wherein the database of documents is a curated set of documents of particular relevance to the query.

7. The method of claim 1 wherein:
each document of the database has been pre-processed using NLP to produce a respective NLP-processed document of reduced size; and
sending the reduced-length version of each document to the first LLM includes sending the respective NLP-processed document of that document to the first LLM.

8. The method of claim 1 wherein the method further comprises:
searching another database of documents, yielding another set of returned documents responsive to the query;
for each other document of another subset of the other set of returned documents, sending a reduced-length version of that other document to the first LLM with a third prompt requesting a summary of that other document, the reduced-length version having been processed using NLP;
in response to receiving the requested summaries of the other subset of documents, sending the summaries of the other subset of documents to the second LLM with a fourth prompt requesting another meta-summary that summarizes the summaries of the other subset of documents;
sending the meta-summary of the subset of documents and the meta-summary of the other subset of documents to the second LLM with a fifth prompt requesting a meta-meta-summary that summarizes those meta-summaries; and
displaying the meta-meta-summary to the user.

9. A system comprising:
user interface (UI) circuitry configured to receive a query from a user;
processing circuitry communicatively coupled to memory configured to respond to the query from the user by:
searching a database of documents, yielding a set of returned documents responsive to the query;
for each document of a subset of the set of returned documents, sending a reduced-length version of that document to a first large language model (LLM) with a first prompt requesting a summary of that document, the reduced-length version having been processed using natural language processing (NLP);
in response to receiving the requested summaries of the subset of documents, sending the summaries of the subset of documents to a second LLM with a second prompt requesting a meta-summary that summarizes the summaries of the subset of documents; and
displaying the meta-summary to the user via the UI circuitry.

10. The system of claim 9 wherein the second LLM is the first LLM.

11. The system of claim 9 wherein the second LLM is different than the first LLM.

12. The system of claim 11 wherein:
the second LLM has a higher token input limit than the first LLM; and
sending the reduced-length version of each document to the first LLM includes, for each document, making a separate call to the first LLM including the reduced-length version of that document and the first prompt.

13. The system of claim 9 wherein the meta-summary includes linked citations to each of the summaries.

14. The system of claim 9 wherein the database of documents is a curated set of documents of particular relevance to the query.

15. The system of claim 9 wherein:
each document of the database has been pre-processed using NLP to produce a respective NLP-processed document of reduced size; and
sending the reduced-length version of each document to the first LLM includes sending the respective NLP-processed document of that document to the first LLM.

16. The system of claim 9 wherein the processing circuitry communicatively coupled to the memory is further configured to respond to the query from the user by:
searching another database of documents, yielding another set of returned documents responsive to the query;
for each other document of another subset of the other set of returned documents, sending a reduced-length version of that other document to the first LLM with a third prompt requesting a summary of that other document, the reduced-length version having been processed using NLP;
in response to receiving the requested summaries of the other subset of documents, sending the summaries of the other subset of documents to the second LLM with a fourth prompt requesting another meta-summary that summarizes the summaries of the other subset of documents;
sending the meta-summary of the subset of documents and the meta-summary of the other subset of documents to the second LLM with a fifth prompt requesting a meta-meta-summary that summarizes those meta-summaries; and
displaying the meta-meta-summary to the user via the UI circuitry.

17. A computer program product, comprising a non-transitory tangible storage medium storing instructions, which, when performed by processing circuitry of a computing system, cause the computing system to respond to a query from a user by:
searching a database of documents, yielding a set of returned documents responsive to the query;
for each document of a subset of the set of returned documents, sending a reduced-length version of that document to a first large language model (LLM) with a first prompt requesting a summary of that document, the reduced-length version having been processed using natural language processing (NLP);
in response to receiving the requested summaries of the subset of documents, sending the summaries of the subset of documents to a second LLM with a second prompt requesting a meta-summary that summarizes the summaries of the subset of documents; and
displaying the meta-summary to the user.

18. The computer program product of claim 17 wherein the meta-summary includes linked citations to each of the summaries.

19. The computer program product of claim 17 wherein:
each document of the database has been pre-processed using NLP to produce a respective NLP-processed document of reduced size; and
sending the reduced-length version of each document to the first LLM includes sending the respective NLP-processed document of that document to the first LLM.

20. The computer program product of claim 17 wherein the instructions, when performed by processing circuitry of the computing system, further cause the computing system to respond to the query by:
searching another database of documents, yielding another set of returned documents responsive to the query;
for each other document of another subset of the other set of returned documents, sending a reduced-length version of that other document to the first LLM with a third prompt requesting a summary of that other document, the reduced-length version having been processed using NLP;
in response to receiving the requested summaries of the other subset of documents, sending the summaries of the other subset of documents to the second LLM with a fourth prompt requesting another meta-summary that summarizes the summaries of the other subset of documents;
sending the meta-summary of the subset of documents and the meta-summary of the other subset of documents to the second LLM with a fifth prompt requesting a meta-meta-summary that summarizes those meta-summaries; and
displaying the meta-meta-summary to the user.
